(19) United States
(12) Patent Application Publication
(10) Pub. No.: US 2009/0139242 A1
(43) Pub. Date: Jun. 4, 2009

(54) Burners for a gas-turbine engine

(76) Inventors: Peter Senior, Levittown, PA (US); Nigel Wilbraham, West Midlands (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/315,318

(22) Filed: Dec. 2, 2008

(30) Foreign Application Priority Data
Dec. 3, 2007 (GB) 0723450.3

(51) Int. Cl. F02C 1/00

(52) U.S. Cl. 60/748; 60/742

(57) ABSTRACT

A burner for a gas-turbine engine has a frustoconical burner shell, at least two swirler arrangements, which are connected to the shell and are spaced apart around the circumference of the shell between its two ends, and a combustion chamber disposed downstream of a wider end of the shell. Each of the swirler arrangements includes an air swirler and a pre-combustion chamber disposed downstream of the air swirler, and a longitudinal axis of each swirler arrangement intersects a line parallel to, and spaced apart from, the longitudinal axis of the shell. The swirler arrangements are preferably connected to the shell at the same axial point.

### CROSS REFERENCE TO RELATED APPLICATIONS

This application claims the benefits of British application No. 0723450.3 filed Dec. 3, 2007 and is incorporated by reference herein in its entirety.

### FIELD OF INVENTION

The present invention relates to a burner for a gas-turbine engine.

### BACKGROUND OF THE INVENTION

Much effort is expended in high-performance burner design to ensure that the fuel and air supplied to the burner are well mixed. This helps to reduce harmful emissions, e.g. NOx, and also reduces the occurrence of hot spots in the burner, which could damage various components of the engine, in particular the turbine and its blades. One of the measures commonly used to enhance mixing is the use of swirlers having a high swirl number. The swirl number is the ratio of spin speed (angular velocity) to forward speed (axial velocity).

A typical can-type burner is disclosed in U.S. Pat. No. 6,532,726 and is reproduced in simplified form in FIG. 1. The burner comprises a burner head 10 connected to a combustion chamber 12, a swirler 14, which is of a high swirl number, being disposed at the junction between the burner head and the combustion chamber. In operation, pilot fuel is injected into the burner head (see arrow 16) and is introduced into a radially central region of the burner. The swirling fuel and air mixture is ignited to produce a flame front 18. Combustion products 20 from the flame proceed down the combustion chamber 12 to the turbine (not shown), where useful work is performed. The diameter of the combustion chamber is shown as D in FIG. 1.

A drawback of the illustrated arrangement is that it results in a high-temperature hot-spot at the outlet of the burner, which is due to centrifugal force acting preferentially on the colder parts of the combustion products, driving them to the outside. This is illustrated in FIG. 2. FIG. 2(a) shows an end-view of the combustion chamber 12 with a value x being a location along the diameter thereof, x taking a value between 0 and D. In FIG. 2(b), which is a graph of temperature versus x, the temperature of the radially central part of the combustion chamber can be seen to be higher than the temperature of the more peripheral parts of the combustion chamber. The temperature difference between the central and peripheral parts is defined as the “traverse”. In FIG. 2(b) the traverse (“traverse 1”) is quite small, which is what would be expected with a low-swirl-number device. By contrast, in FIG. 2(c), the traverse (“traverse 2”) is considerably larger, which is the situation where a swirler with a high swirl number is employed. A large traverse is undesirable. This is because, although the presence of cooler combustion gases at the combustion-chamber walls is in itself desirable, too high a difference in temperature over the diameter of the combustion-chamber outlet produces unwanted thermal stresses in the nozzle guide vanes and, to a lesser extent, in the turbine blades downstream of those vanes. Hence there is a need to reduce traverse as much as possible.

The problem of a high traverse may be dealt with by introducing improved and targeted cooling in the nozzle guide vane assemblies, or by employing discrete trimming jets in the burner or in the transition duct that links the burner with the turbine assembly. This is exemplified in FIG. 3, which shows a simplified axial section of a can-type burner 30, such as that illustrated in U.S. Pat. No. 6,532,726, connected to a transition duct 32, which in turn leads into the nozzle guide vanes 34 adjacent to the rotating turbine section (not shown). In order to change the combustion profile at the nozzle-guide-vane end, cold air (so-called “trimming air”) is blown in through openings 36 in the combustion chamber and/or through one or more openings 38 in the transition duct 32 near its downstream end. This causes mixing between the trimming air and the combustion products in the central region, evening out the distribution over the cross-section of the transition duct and diluting any hot spots that would otherwise occur.

A drawback of this approach, however, is that it is relatively inefficient and leads to problems when the machine power has to be increased, since the trimming air is derived from the compressed air normally supplied to the main swirler 14 (see FIG. 1). Because the swirler requires more air to increase the power by burning more fuel without increasing emissions, this extra air has to be taken from the trimming supply.

Other burners are known (see, e.g., EP 1510755 and EP 0704657), which have a lower swirl number and which direct pilot fuel away from the swirling core. However, these sacrifice premixing efficiency and therefore produce higher emissions at a given flame temperature. Other solutions rely on the interaction between multiple low-swirl burners in an annular combustor configuration, but these have the disadvantage of being inapplicable to the can-type burner, which is preferred in small engines due to its ease of maintenance and the fact that it has a smaller surface area to keep cool. Furthermore, these annular solutions do not take advantage of the geometry of the can-type burner, which, when two or more swirlers are employed, encourages the streams from these swirlers to wrap around themselves and strongly interact with each other. It should be noted that, although annular solutions can be envisaged which can simulate this, the effect is not as marked as in the can-type burner case.

### SUMMARY OF INVENTION

In accordance with a first aspect of the invention there is provided a burner for a gas-turbine engine, comprising: a frustoconical burner shell; at least two swirler arrangements connected to said frustoconical burner shell at points intermediate the ends thereof, said swirler arrangements being spaced apart around a circumference of said frustoconical burner shell, and a combustion chamber disposed downstream of a wider end of said frustoconical burner shell, each of said swirler arrangements comprising: an air swirler, and a pre-combustion chamber disposed downstream of said air swirler, and a longitudinal axis of each of said swirler arrangements intersecting a line parallel to, and spaced apart from, a longitudinal axis of said frustoconical burner shell, a flow direction of a fuel-air mix in the burners being generally toward said combustion chamber.

The swirler arrangements are preferably spaced apart substantially equidistantly around the circumference.

An angle of intersection of the longitudinal axis of each of the swirler arrangements with a respective line parallel to, and spaced apart from, said longitudinal axis of the frustoconical burner shell is preferably such that the intersection occurs in a plane defined by the wider end of the frustoconical burner shell, plus or minus a fraction of the length of the frustoconical burner shell. This fraction may be 20%.

The swirler arrangements may be connected to the frustoconical burner shell at substantially the same axial point, and the angle of intersection may be substantially the same for each of the swirler arrangements.

One of the swirler arrangements may be connected to the burner shell at an axial point more remote from the combustion chamber than another of the swirler arrangements, an angle of intersection associated with the one of said swirler arrangements being smaller than that associated with the other swirler arrangement.

A narrower end of said frustoconical burner shell may be an inlet for the supply of air at a radially central part of said frustoconical burner shell. This narrower end may also serve as an inlet for the supply of pilot fuel and may also be provided with its own air swirler.

The air swirlers of the swirler arrangements preferably have a high swirl number.

One of the swirler arrangements may be arranged to be fed with a reduced quantity of main fuel.

The invention in a second aspect thereof provides a combustor arrangement comprising a plurality of burners as described above, wherein a radial component of the longitudinal axis of the swirler arrangements of at least one of the burners lies approximately tangentially to a circle, on which the burners lie, or approximately along a radius of this circle, or at any angle therebetween.

The combustor arrangement may be an annular combustor device.

A third aspect of the present invention is constituted by a silo combustor, which comprises one or more burners as described earlier.

### BRIEF DESCRIPTION OF THE DRAWINGS

Embodiments of the invention will now be described, by way of example only, with reference to the drawings. In the drawings,

FIG. 1 is an axial section through a known can-type burner;

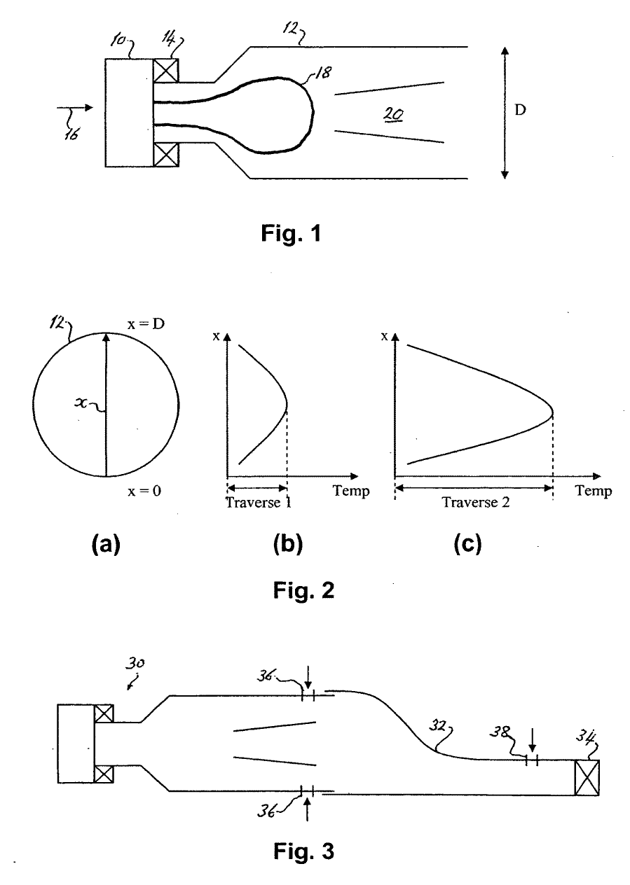

FIG. 2(a) is an end-view of the burner shown in FIG. 1, while FIGS. 2(b) and 2(c) are graphs of radial location versus exit temperature for different burner arrangements;

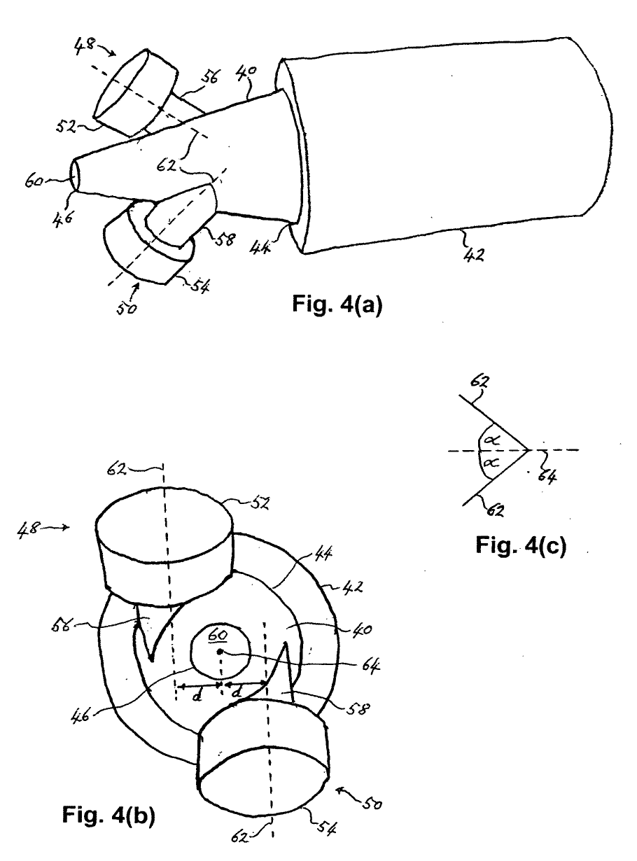

FIG. 3 is an axial section through a burner as shown in FIG. 1, but including a trimming-air facility;

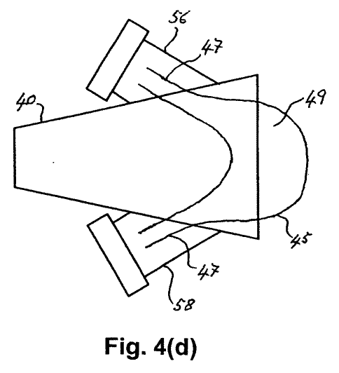

FIGS. 4(a) and 4(b) are perspective- and end-views, respectively, of an embodiment of a burner in accordance with the invention, while FIG. 4(c) shows an angle of inclination of the swirler arrangements, which are employed in the burner, to the axis of the combustor, and FIG. 4(d) shows a flame position in the burner;

FIG. 5(a) is an axial section through an example of a swirler arrangement for use in a burner in accordance with the present invention, while FIG. 5(b) is a section looking along line Vb;

FIG. 6(a) is a simplified side view of the burner of FIGS. 4(a) and 4(b) in a first use scenario, with FIG. 6(b) being a graphical representation of two examples of traverse arising from such a burner;

FIGS. 7-9(a) are simplified side views of the burner of FIGS. 4(a) and 4(b) in second, third and fourth use scenarios, FIG. 9(b) being an exemplary profile and FIG. 10 being a graph of main-fuel quantity versus engine load for the fourth scenario;

FIG. 11 is a graph of mass flow versus load in a further variant of the burner in accordance with the embodiment;

FIG. 12 is an example of an arrangement of multiple can-type burners in accordance with the embodiment;

FIGS. 13(a) and 13(b) show two possible orientations of the swirler arrangements in the combustors shown in FIG. 12;

FIGS. 14(a) and 14(b) are an end-view and a longitudinal sectional view, respectively, of a known annular type of combustor system, FIG. 15 showing, in simplified end-view, the application of the burner according to the invention to this known system;

FIG. 16 is an end-view of a second embodiment of the burner according to the invention; and

FIGS. 17, 18 and 19(a), (b) and (c) are views of a known silo combustor, in which one or more burners in accordance with the present invention are implemented in place of more conventional burners.

### DETAILED DESCRIPTION OF INVENTION

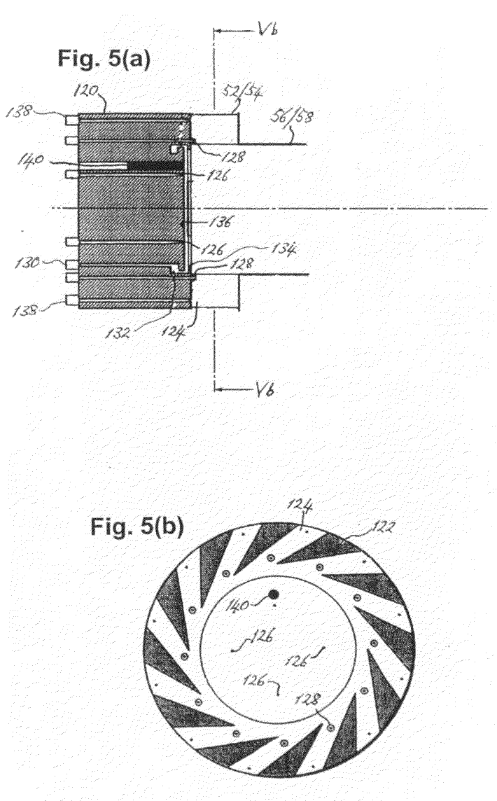

Referring now to FIGS. 4(a) and 4(b), these show a perspective view and an end-view, respectively, of a burner according to the invention in an embodiment thereof. The burner comprises a frustoconical burner shell 40 attached to a combustion chamber 42. Attached to the shell 40 at diametrically opposite points on the circumference of the shell intermediate its larger-diameter end 44 and its smaller-diameter end 46 are two swirler arrangements 48, 50. These swirler arrangements are orientated so that their longitudinal axes 62 both form an angle a with the longitudinal axis 64 of the combustor (see FIG. 4(c)) and are offset from that longitudinal axis 64 by a distance d (see FIG. 4(b)).

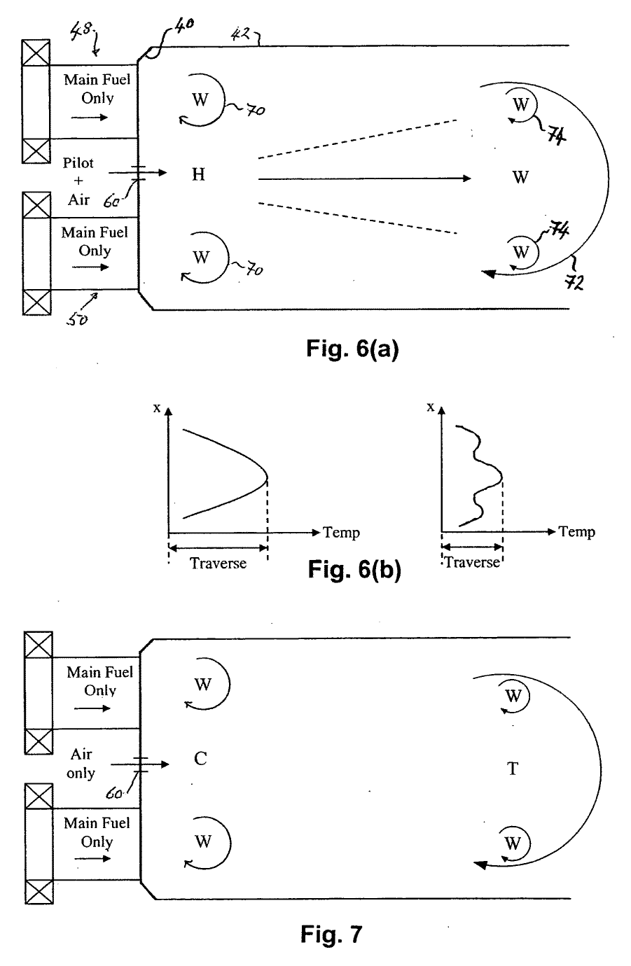

The swirler arrangements comprise an air swirler 52, 54 of the high-swirl-number type mounted to a pre-combustion chamber 56, 58. Air is introduced into the pre-combustion chambers through the swirlers, this air being mixed with fuel, which is fed into the swirler arrangements, the resulting swirling fuel-air mixture being ignited to produce the required combustion products for driving a downstream turbine. The swirler arrangements 48, 50 may be configured as disclosed in U.S. Pat. No. 6,532,726 mentioned earlier. Thus, as illustrated in FIGS. 5(a) and 5(b), a head portion 120 is attached to the upstream end of a radial swirler 52/54 (in practice, an axial swirler might be used instead), which in turn is attached at its downstream end to a pre-combustion chamber 56/58 (see also FIG. 4). The swirler has a series of vanes 122, which define passages 124, into which air is introduced. The head portion 120 contains a series of pilot-fuel passages 126 and a series of main-fuel passages 128 for the introduction of liquid fuel into the head portion 120. On the other hand, gaseous pilot fuel will be introduced into a passage 130, from which it reaches an annular gallery 132, from which in turn it is deflected by a circumferential lip 134 across a central portion 136 of the head portion. Main gaseous fuel is introduced through passages 138. An igniter 140 is provided to ignite the fuel-air mix passing from the swirler 52/54 to the pre-combustion chamber 56/58.

The swirler arrangements 48, 50 are orientated such as to produce a flame profile as illustrated in FIG. 4(d) (which is a simplified representation of the burner), in which it can be seen that the flame 45 starts off as two limbs 47 located in the pre-combustion chambers 56, 58. These limbs widen out and coalesce further downstream at the wider end of the frustoconical shell 40, finally emerging as a common flame front 49 located in the upstream end of the combustion chamber (not shown in FIG. 4(d)). This flame profile can be achieved by arranging for the angle a to be such that the points of intersection 63 (see FIG. 4(c)) of the longitudinal axes 62 of the two swirler arrangements with lines parallel to (and offset from) the longitudinal axis 64 of the burner lie on a plane situated at the wider end 44 of the shell±approximately 20% of the axial length of the shell. The exact location of the flame will depend on a number of factors mainly including the aerodynamic flow field with its recirculation zone, the re-ignition of the fresh fuel-air mixture providing self-sustaining continuous combustion, and the propagation speed of the flame. The aerodynamic flow field for a given geometric configuration is affected by the swirler arrangement (48/50) and the volume expansion taking place due to the heat release. With an increased pressure drop, which is typically the case for higher loads, the flame tends to be pushed further out, i.e. in the downstream direction, where it is stabilized by the flow induced by the swirler arrangement and the higher temperature of the flame ensures that combustion can be maintained. For a low-load condition, which also involves a lower turbine inlet temperature corresponding to a lower flame temperature, the pressure drop decreases and the combustion process slows down. This in turn affects the aerodynamic flow field, which typically means that the flame will be positioned further in, i.e. in the upstream direction, compensating for the effect of the lower heat-release on stability.

The location of the flame stabilization point can be moved by the use of pilot flames, which will act as flame holders feeding energy into the aerodynamic flow field where the pressure drop is too high for the main flame to re-ignite the incoming fuel-air mixture, but would simply extinguish otherwise. Depending on the material used for the frustoconical shell, the flame can be allowed to stabilize in different locations even inside the shell. For a burner made of a material with a lower melting point than the flame temperature (e.g., most metals), it is preferable not to have the flame far inside the shell. However, if the material is, for example, a ceramic material or a superalloy, this can be allowed as long as flashback does not occur. Flashback is when the flame is spreading or progressing in low-velocity layers of the flow field, typically starting in the boundary layers on surfaces near the flame.

Additional air is introduced into an opening 60 at the narrow end of the shell. Pilot fuel may be included along with the air. This additional air (and fuel) is fed between the rotating flow fields issuing from the swirler arrangements 48, 50. The combination of the two hot fuel-air flows from the swirler arrangements 48, 50 and the cooler air flow through the opening 60 of the shell results in rapid mixing. This is explained by considering that the higher-density cooler air from the shell inlet 60 will tend to centrifuge outward through and between the surrounding hot swirling flow fields, which causes very rapid mixing of the hot and cold streams. At the same time, because the hot cores of the two high-swirl swirler arrangements 48, 50 are not aligned with the longitudinal axis of the burner, these cores will tend to migrate the opposite way toward the cold shell air, due to the relative density of the hot and cold flows. This process enhances the mixing effect even further.

The effect of the invention as just described is a reduction in traverse due to the enhanced mixing that takes place. A further benefit is a reduction in harmful emissions relative to low-swirl burners achieving an equivalent traverse. Since the longitudinal axes of the swirler arrangements 48, 50 are not aligned with the combustor axis, axial acoustic-wave modes from the combustion chamber cannot couple simultaneously to all fuel and air inlet points in the swirlers. This effect tends to greatly reduce the tendency toward thermo-acoustic pulsations, which is a known limitation on all types of lean-premix systems.

Four scenarios will now be described, each dealing with a different combination of incoming main and pilot fuel and air.

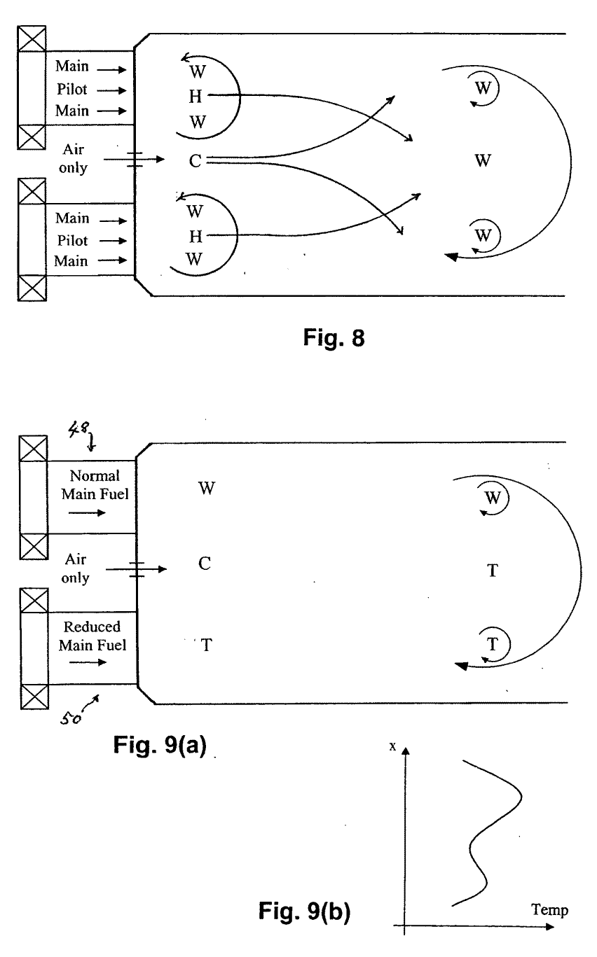

Firstly, it is assumed that main fuel and air are introduced into the swirler arrangements 48, 50 and pilot fuel and air are introduced into the opening 60 of the shell. This is shown in FIG. 6(a), which is a much simplified schematic representation of the combustor, in which the swirler arrangements 48, 50 are not shown inclined with respect to the longitudinal axis of the burner and the shell 40 is merely suggested. The combusted pilot-fuel and air mixture creates an initial hot region (H) in the central region of the combustion area, to produce a robust flame stabilisation source, while the main-fuel and air mixture in the individual swirler arrangements 48, 50 produces a warm region (W) in the peripheral regions either side of the hot region. The arrows 70 represent the swirl of the combustion products as they move in a downstream direction. In practice, the arrows 70 lie in a plane orthogonal to the page. As the three flows progress along the shell and combustion chamber, the hot flow mixes with the adjacent warm flows to provide a central region with a reduced temperature (shown here as warm (W), but in reality veering slightly towards hot), and peripheral regions which are more uniformly warm than the peripheral regions further upstream. The downstream swirl behaviour is shown by arrows 72 and 74, which are to be understood similarly to arrows 70. It should be noted that interactions between the flows from the swirler arrangements 48, 50 and the shell 40 and combustion chamber 42 will mean that rotation about the axis of the burner and merging of the original swirling flows from the two swirler arrangements will occur. This is represented by the use of different arrows 72, 74.

FIG. 6(b) contrasts the upstream and downstream regions in terms of traverse. The traverse at the upstream end is large with a monotonic profile, while the traverse at the downstream end is much reduced and with a somewhat undulating profile. The improved traverse at the downstream end is clearly evident.

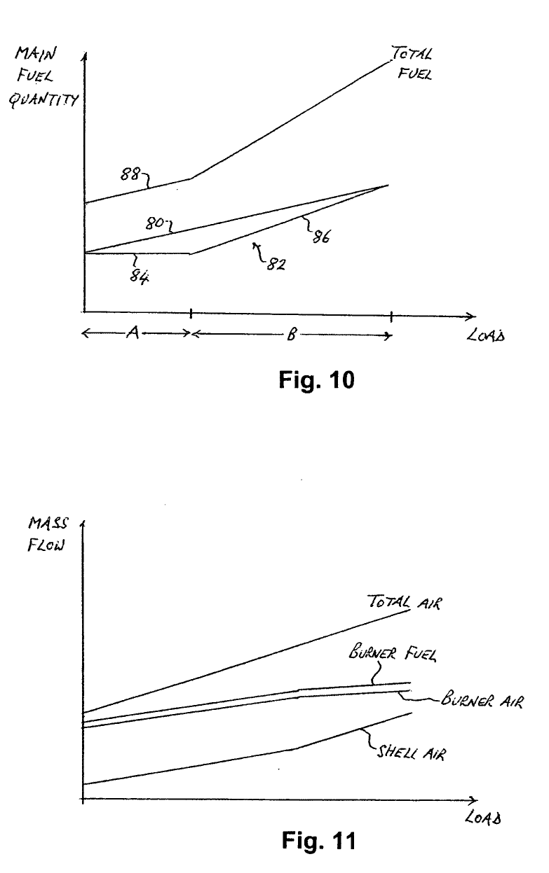

In a second scenario, illustrated in FIG. 7, main fuel only and air are again introduced into the swirler arrangements 48, 50, while air only is introduced into the narrow end of the shell through opening 60. This gives rise initially to a (relatively) cold region (C) in the radial centre of the shell and combustion chamber, the peripheral regions being, as in the FIG. 6 case, warm (W). Further downstream, due to the interaction of the central and peripheral flows, and therefore mixing of the cold with the warm, the profile becomes more as shown, with the central region being somewhere between cold and warm (i.e. tepid (T)) and being radially wider than at the upstream end. Again, the result is a narrower traverse, and one which undulates rather than being monotonic. This pattern can be used at high load or full load, where the main burners are hot enough to be robustly stable on their own and the additional small emissions penalty of the pilot supply can be advantageously avoided.

FIG. 8 shows the third scenario. In this scenario both main fuel and pilot fuel (with air) are fed to the swirler arrangements 48, 50, while air only is fed into opening 60. This creates an initial profile as shown at the upstream location, in which a cold region (C) lies in the centre, and warm (W) and hot (H) regions lie peripherally to the cold region. As the flows progress, the cold area moves outwards, while the hot areas move inwards, resulting in a more even downstream profile, which therefore exhibits a narrow traverse. This might be used at very low load conditions, where a pilot fuel supply is needed within the swirler arrangements themselves, in order to keep them robustly stable. This represents a condition, in which the inevitable increase in emissions is proportionately less of a problem, because of the vastly reduced amount of fuel being burned and because of the restricted amount of time during which most users would operate in this mode.

Finally, a fourth scenario is illustrated in FIG. 9. This scenario helps to achieve better low-emissions “turn-down” performance. Turn-down may be defined as the load range over which both the flame and the emissions level in the burner are stable. This range is limited due to the fact that, at reduced load, the air flow into the burner normally reduces more slowly than the fuel flow into the burner, so that the temperature of the flame drops, eventually extinguishing or pulsating. The low-emissions qualification here signifies the range of load over which a stable flame is achieved, whilst simultaneously keeping the emissions down. Enhanced low-emissions turn-down is obtained here by introducing different ratios of main fuel to air into the two swirler arrangements and by introducing air only into the shell through the opening 60. Furthermore, swirler arrangement 48 may have a high swirl number, while swirler arrangement 50 has a low swirl number, so that the two burners have similar emissions at their respective air-fuel ratios at full load. The fuel-input regime is depicted in FIG. 10, which is a graph of fuel quantity versus load. Curve 80 represents the increase in main fuel to burner 48 as the engine load increases, and can be seen to be linear. On the other hand, curve 82, which represents the main fuel into burner 50, is piecewise linear, with a section 84 being a constant fuel feed over an initial load range A and a section 86 being a linearly increasing fuel feed over a subsequent load range B up to full load. The total fuel feed into the two burners is shown as curve 88.

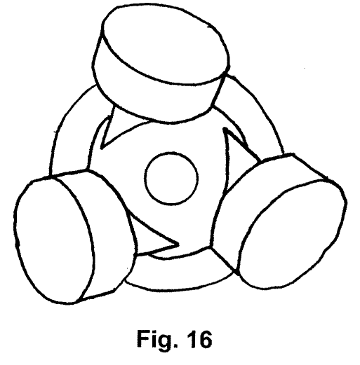

Because swirler arrangement 48 has a higher swirl number than swirler arrangement 50, the fuel and air proceeding through it is better mixed than the fuel-air mixture proceeding through swirler arrangement 50. Consequently, even though swirler arrangement 48 has proportionately less air and runs hotter than swirler arrangement 50, the two produce similar emissions at full load. In addition the differences in the flow fields from the two swirler arrangements in this scenario further help to reduce the tendency to generate pulsations, which can be damaging to the turbine components. Interaction between the warm, cold and tepid flows shown upstream in FIG. 9 results in a somewhat smoothed-out distribution of both warm (W) and tepid (T) areas at the downstream end. With suitable orientation of the swirler arrangements 48, 50 radially in relation to the downstream turbine-blade arrangement (this will be described further later on in connection with FIGS. 13(a) and 13(b)), this scenario could be useful for tailoring the profile for a particularly advantageous turbine profile (such as cooler high-stress root areas on rotating blades). Such a profile is shown in FIG. 9(b).

Although in some of the above scenarios it has been assumed that no pilot fuel will be introduced into the shell, such fuel could be introduced in order to further enhance the stability of the combustion process.

In all of the arrangements described above it is assumed that the main and pilot fuel will be gas rather than liquid. However, with suitable aerothermal design part or all of the main fuel in liquid form could alternatively be introduced close to the pilot fuel through opening 60, rather than through the swirler arrangements 48, 50. One specific arrangement would be to design the main liquid fuel “injector” to spray the bulk of its fuel at and into the airstreams emerging from the two prechambers. This could be done using a fan-spray nozzle or two appropriately directed swirl or other type of atomisers. Since the air stream through opening 60 will have low or zero swirl, the droplets will have some time to spread and begin evaporating prior to meeting the strongly swirling flows of swirler arrangements 48, 50. Thus it is less likely that heavy droplets will be centrifuged and hit the walls of the shell, before they have had time to evaporate fully. Typically, this problem would occur at lower loads (during turndown), where the preheat pressure and temperature of the air are lower. In this case, the liquid pilot nozzle itself might do double duty as a partial route for the introduction of “main” liquid fuel.

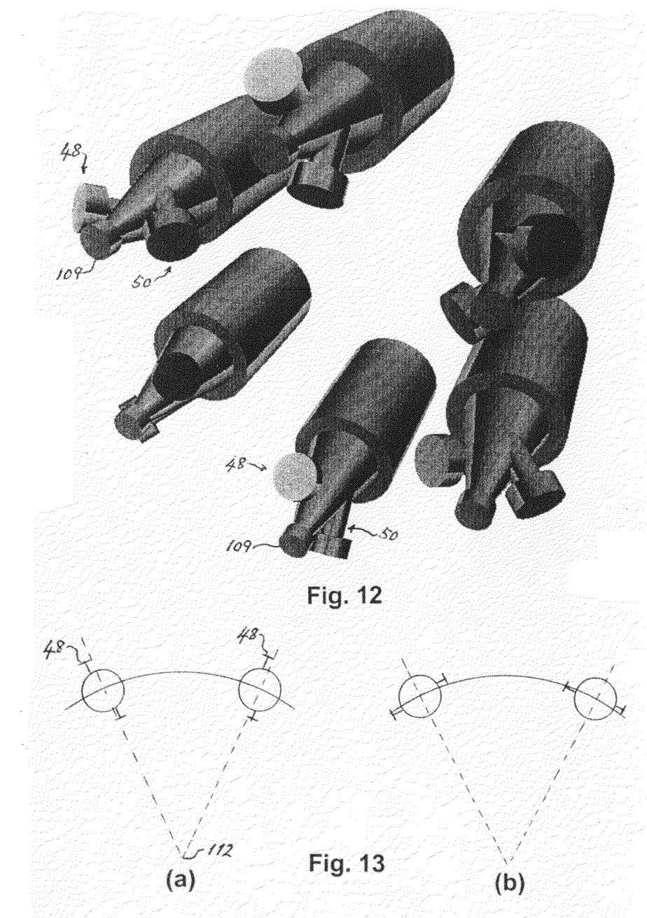

A further variant of the invention involves running the two swirler arrangements 48, 50 at an air-fuel ratio somewhere near that at full load, while varying the air, and possibly also the pilot fuel, entering the opening 60 of the shell 40. To achieve this a valve is included in the air inlet to the shell, in addition to the valve already required for the injection of fuel at this location. FIG. 11 is a graph of mass flow of fuel and air into the burner against engine load. If the pilot is operating in premixed mode, this would provide an alternative method of achieving low-emissions turndown at high load with the same general configuration. It should be noted that suitable aerodynamic design may permit the pilot to operate as a premixed stream when small amounts of gas fuel are pumped through it at high load, while at other load conditions it acts as a more stable diffusion-type flame with proportionately more fuel entering the pilot injection point.

There are a number of ways of configuring a valve, which is required for the pilot-flow in the arrangements shown in FIGS. 9 and 10 and FIG. 11. Examples of air-flow control valves, which may be adapted for use in the present invention, are described in U.S. Pat. No. 6,892,543, GB 1601218, U.S. Pat. No. 4,141,495, U.S. Pat. No. 5,351,474 and EP 0571782.

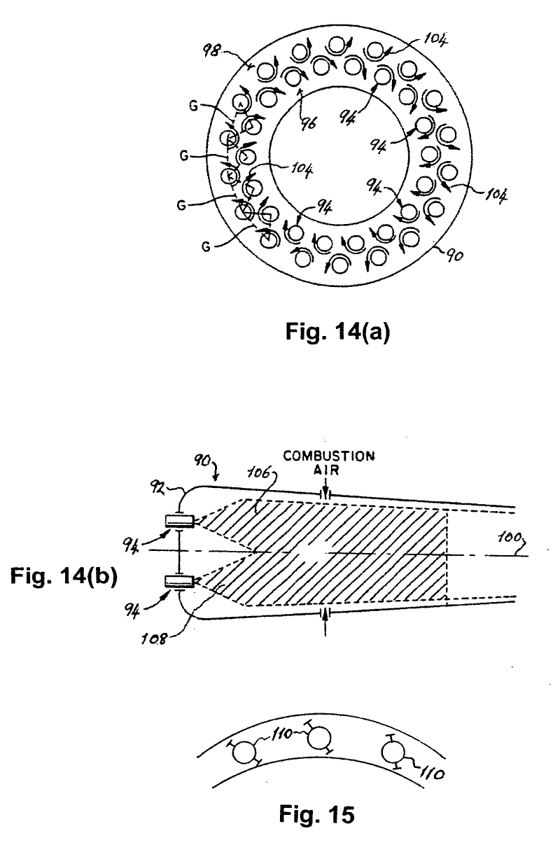

A practical can-type combustor system normally employs more than one such burner spaced apart around the circumference of the engine radially outside the compressor. A perspective view of a six-combustor system is shown in FIG. 12. The orientation of the swirler arrangements 48, 50 can be varied to suit the configuration of the engine as a whole. Thus, as shown in FIGS. 13(a) and (b), respectively, the swirler arrangements (which are shown in simplified form as a “T” shape) may be orientated to lie approximately radially relative to the longitudinal axis of the engine, or approximately tangentially to the circle on which the burners are located, or at any angle in between. It may be preferred to err more on the side of the FIG. 13(b) case, since this ensures that there will be no mechanical interference between the swirlers and the compressor located nearby, although under normal circumstances an angle midway between that shown in FIGS. 13(a) and 13(b) will prove acceptable. This freedom of orientation also enables the locations of the traverse peaks to be varied, which may prove useful in tailoring the turbine-inlet profile.

Incidentally, FIG. 12 shows a swirler 109 attached to the opening at the narrow end of the frustoconical shell of each of the burners. Like the swirlers 52 and 54 of the swirler arrangements 48, 50, this may be an axial or a radial swirler and helps to strengthen the interaction between the cold air entering the shell and the combustion products from the burners 48, 50. This extra swirler may be used in the earlier-described arrangements also.

As was mentioned earlier, the possibility, illustrated in FIGS. 13(a) and 13(b), of varying the orientation of the swirler arrangements 48, 50 can be used to advantage in ensuring that a particular temperature profile (e.g. as shown in FIG. 9(b) in connection with FIG. 9(a)) obtains at the turbine end of the combustion chamber or its associated transition duct. In the case shown in FIG. 9, this would mean arranging for the swirler arrangement 48, into which normal main fuel is introduced, to be located radially remote from the longitudinal axis of the turbine. FIG. 13(a) shows swirler arrangement 48 and the longitudinal axis 112 in that scenario.

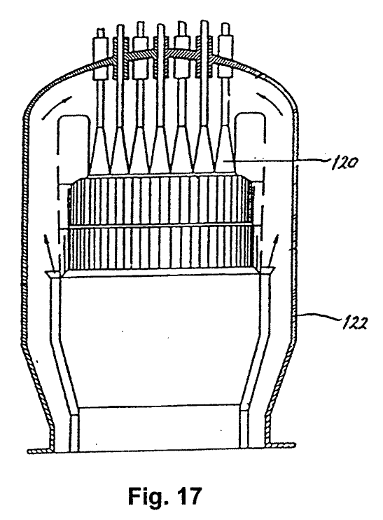

The can-type burner described above may also be employed as part of an annular combustor arrangement. A typical annular combustor arrangement is described in U.S. Pat. No. 4,991,398, issued to assignee United Technologies Corporation. FIGS. 14(a) and 14(b) show a basic principle of a technique described in this patent. An annular combustor 90 has disposed at a dome end 92 thereof a number of fuel nozzles 94. The nozzles 94 are circumferentially spaced apart in two rows—a first, radially inner row 96 and a second, radially outer row 98, referred to a longitudinal axis 100 of the combustor. The nozzles of one row interleave with those of the other row, so as to create a triangular configuration shown as G in FIG. 14(a). Each of the nozzles has its own swirler device and the directions of the swirl in each case are shown by the arrows 104. Reference numerals 106 and 108 represent the fuel-spray cones as they leave the nozzles.

In this embodiment, adjacent pairs of nozzles 94 are replaced by a burner as hereinbefore described—see FIG. 15, which shows a single row of burners 110 in accordance with the invention. This has the advantage that adjacent swirler arrangements 48, 50 in each burner (see FIGS. 4(a) and 4(b)) act as “preferred partners” to each other, in a manner which is impossible with the nozzles 94 in FIG. 14(a), since any one nozzle in FIG. 13(a) has two possible partners with which to interact. Having a preferred partner strengthens the interaction between the burners and also the predictability of the turbine entry pattern. In addition, the near-field interaction between each pair of swirler arrangements 48, 50 is isolated from the cross-flow, which is generated around an annular combustor such as is illustrated in FIGS. 14(a) and 14(b). This cross-flow tends to weaken the burner stability and the resistance to thermo-acoustic pulsation. A further advantage is that, due to the use of the frustoconical shell 40 (see FIGS. 4(a) and 4(b)), it is possible to place the burners in various orientations relative to the longitudinal axis of the shell, whereas in the conventional annular arrangement the placing of the nozzles is more restricted by the need to fire more or less directly down the annulus

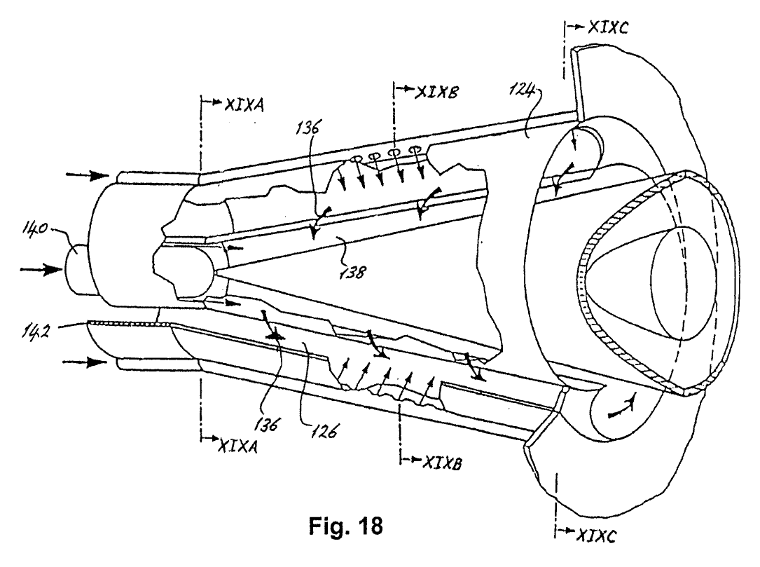

Although only two swirler arrangements have been shown in FIGS. 4(a) and 4(b), it is possible to employ more than two approximately equidistantly spaced around the shell. A configuration including three swirler arrangements, which forms a second embodiment of the invention, is shown in FIG. 16. Whether or not it is advantageous to employ more than two depends on the application. Where the burner is small, there will be little advantage. Indeed, the use of three or more swirler arrangements could easily be a disadvantage, since then they would be smaller with consequently greater constraints on mechanical tolerances, hence greater difficulties in manufacture. On the other hand, a larger burner might easily employ more than two, the advantage then being greater control over the fuel-air characteristics in relation to load, etc. This would represent an extension of the principle shown in FIGS. 9 and 10, in which fuel-air staging takes place over several swirler arrangements instead of just the two shown in these figures. An additional factor is the possibility of stocking swirler arrangements of a standard size, with more of such swirler arrangements being employed in a larger burner, and fewer in a smaller burner. This has clear advantages in terms of manufacturing cost and servicing.

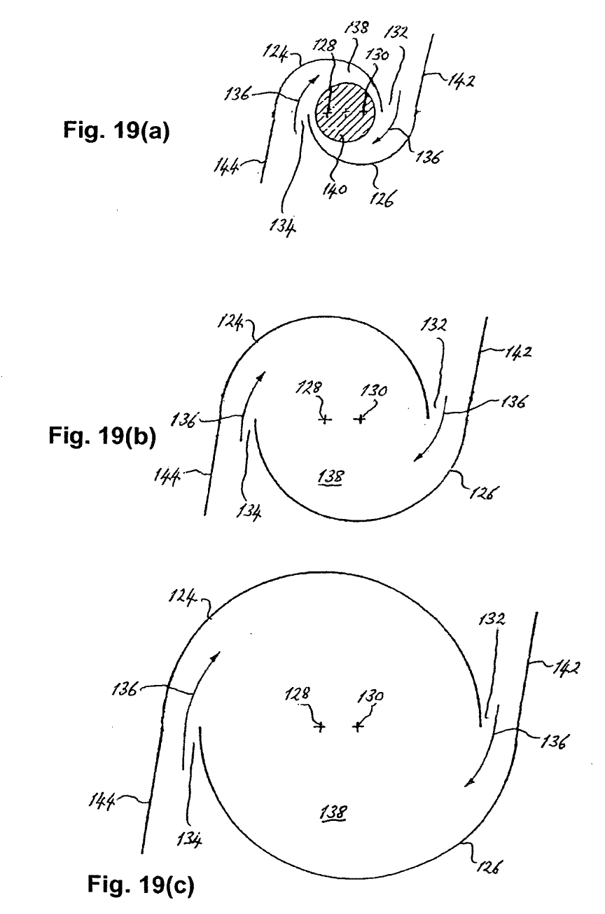

The burner of the present invention may be put to advantageous use in a silo combustor. An example of a silo combustor is described in EP 0571782, filed in the name of Asea Brown Boveri, AG. The combustor (see FIG. 17) comprises a large number of premix burners 120 distributed around the dome-end of the combustion chamber 122. The burners 120 are each configured as shown in FIG. 18. FIGS. 19(a), (b) and (c) show sections through the burner along lines XIXA, XIXB and XIXC, respectively. The burners consist of two half-conical portions 124, 126 having axes 128, 130, which are offset from each other. This offset has the effect of creating two diametrically opposite spaces 132 and 134 for the ingress of compressed air, as shown by the arrows 136. The air flows into a combustion space 138 between the two half-conical portions 124, 126, where it mixes with fuel introduced by a fuel injector 140. The compressed air is guided into the combustion space by two guide plates 142, 144, which are not shown in full in FIG. 18 for the sake of clarity.

One problem with the arrangement just described is that, since there are a large number of these burners in the silo combustor, there is very little space left between the burners, giving poor aerodynamics at the point where the wider end of the conical burner joins the rest of the combustor (see FIG. 17). In order to solve this problem, it is possible to substitute at least some of the burners with the burner according to the invention, as described above. Since the swirler arrangements 48, 50 are generally located at an intermediate point between the ends of the frustoconical shell 40, more free space will be available between the burners.

In all of the arrangements described above, control of fuel-air mixing in the burner can be achieved by varying one or more of: the swirl number of the swirlers in the individual burners, the offset distance d, the angle of inclination a and the axial placement of the swirler arrangements. One possible orientation of the swirler arrangements relative to the shell has already been described, namely setting the angle a so that, for the axial location at which the swirler arrangements connect to the shell, the axes 62 (see FIG. 4(c)) of the swirler arrangements intersect with respective lines parallel with the longitudinal axis 64 of the burner somewhere in the region of the wider end 44 of the shell. The optimal point of such intersection would be decided by detailed flow modelling for particular swirl numbers and angles, a procedure which is within the routine activity of the skilled person. In practice, however, it is anticipated that the intersection location is likely to be at the shell-end 44 plus/minus around 20% of the axial length of the shell, as mentioned earlier. Offset distance d will be determined by the required degree of interaction between the pilot air (and/or fuel) flow at the radial centre of the shell and the fuel-air flows from the swirler arrangements, which in turn is determined by the temperature profile which might be required at the downstream end of the combustion chamber, or even further downstream near the turbine blades.

Although it has been assumed that the burners will have a high swirl number, the invention also envisages a situation, in which they have a low swirl number. Such a situation, however, is not preferred, since a low swirl number means less efficient mixing generally, and higher emissions. Furthermore, it is normally only with high-swirl burners that the traverse problem is very significant.

1.-16. (canceled)

17. A burner for a gas-turbine engine, comprising:
a frustoconical burner shell;
a plurality of swirler arrangements connected to the frustoconical burner shell at points intermediate the ends thereof, the swirler arrangements being spaced apart around a circumference of the frustoconical burner shell; and
a combustion chamber arranged downstream of a wider end of the frustoconical burner shell, wherein each swirler arrangement has:
an air swirler, and
a pre-combustion chamber arranged downstream of the air swirler, and a longitudinal axis of each of the swirler arrangements intersecting a line parallel to, and spaced apart from, a longitudinal axis of the frustoconical burner shell, and a flow direction of a fuel-air mix in the burners being generally toward the combustion chamber.

18. The burner as claimed in claim 17, wherein the swirler arrangements are spaced apart substantially equidistantly around the circumference.

19. The burner as claimed in claim 18, wherein an angle of intersection of the longitudinal axis of each of the swirler arrangements with a respective line parallel to, and spaced apart from, the longitudinal axis of the frustoconical burner shell is such that the intersection occurs in a plane defined by the wider end of the frustoconical burner shell.

20. The burner as claimed in claim 19, wherein the fraction of the length of the frustoconical burner shell is 20%.

21. The burner as claimed in claim 20, wherein the swirler arrangements are connected to the frustoconical burner shell at substantially the same axial point, and the angle of intersection is substantially the same for each of the swirler arrangements.

22. The burner as claimed in claim 20, wherein one of the swirler arrangements is connected to the burner shell at an axial point more remote from the combustion chamber than another of the swirler arrangements, an angle of intersection associated with one of the swirler arrangements being smaller than that associated with the other swirler arrangement.

23. The burner as claimed in claim 22, wherein a narrower end of the frustoconical burner shell is an inlet for a supply of air at a radially central part of the frustoconical burner shell.

24. The burner as claimed in claim 23, wherein the narrower end of the frustoconical burner shell is also an inlet for a supply of pilot fuel.

25. The burner as claimed in claim 24, further comprising an air swirler connected to the narrower end of the frustoconical burner shell.

26. The burner as claimed in claim 25, wherein the air swirlers of the swirler arrangements have a high swirl number.

27. The burner as claimed in claim 26, wherein one of the swirler arrangements is fed with a reduced quantity of main fuel.

28. A combustor arrangement, comprising:
a plurality of burners where each burner has:
a frustoconical burner shell,
a plurality of swirler arrangements connected to the frustoconical burner shell at points intermediate the ends thereof, the swirler arrangements being spaced apart around a circumference of the frustoconical burner shell, and
a combustion chamber arranged downstream of a wider end of the frustoconical burner shell, where each swirler arrangement has:
an air swirler, and
a pre-combustion chamber arranged downstream of the air swirler, and a longitudinal axis of each of the swirler arrangements intersecting a line parallel to, and spaced apart from, a longitudinal axis of the frustoconical burner shell, and a flow direction of a fuel-air mix in the burners being generally toward the combustion chamber, and
wherein a radial component of the longitudinal axis of the swirler arrangements of at least one of the burners lies approximately tangentially to a circle, on which the burners are arranged, or approximately along a radius of the circle, or at any angle therebetween.

29. The combustor arrangement as claimed in claim 28, wherein the swirler arrangements are spaced apart substantially equidistantly around the circumference.

30. The combustor arrangement as claimed in claim 29, wherein an angle of intersection of the longitudinal axis of each of the swirler arrangements with a respective line parallel to, and spaced apart from, the longitudinal axis of the frustoconical burner shell is such that the intersection occurs in a plane defined by the wider end of the frustoconical burner shell.

31. The combustor arrangement as claimed in claim 28, wherein the burners form part of an annular combustor device.

32. A silo combustor, comprising:
a silo combustor housing;
a plurality of burners arranged with and in communication with the combustor housing, where each burner has:
a frustoconical burner shell,
a plurality of swirler arrangements connected to the frustoconical burner shell at points intermediate the ends thereof, the swirler arrangements being spaced apart around a circumference of the frustoconical burner shell, and
a combustion chamber arranged downstream of a wider end of the frustoconical burner shell, where each swirler arrangement has:
an air swirler, and
a pre-combustion chamber arranged downstream of the air swirler, and a longitudinal axis of each of the swirler arrangements intersecting a line parallel to, and spaced apart from, a longitudinal axis of the frustoconical burner shell, and a flow direction of a fuel-air mix in the burners being generally toward the combustion chamber, and
wherein a radial component of the longitudinal axis of the swirler arrangements of at least one of the burners lies approximately tangentially to a circle, on which the burners are arranged, or approximately along a radius of the circle, or at any angle therebetween.

33. The silo combustor as claimed in claim 32, wherein the swirler arrangements are spaced apart substantially equidistantly around the circumference.

34. The silo combustor as claimed in claim 33, wherein an angle of intersection of the longitudinal axis of each of the swirler arrangements with a respective line parallel to, and spaced apart from, the longitudinal axis of the frustoconical burner shell is such that the intersection occurs in a plane defined by the wider end of the frustoconical burner shell.
